(19) United States
(12) Patent Application Publication
(10) Pub. No.: US 2023/0384804 A1
(43) Pub. Date: Nov. 30, 2023

(54) SYSTEMS AND METHODS FOR TIMELY MOVING OF A PACKAGE INSIDE A DELIVERY VEHICLE

(71) Applicant: Ford Global Technologies, LLC, Dearborn, MI (US)

(72) Inventors: Yifan Chen, Ann Arbor, MI (US); John Vincent, Livonia, MI (US); Kurt Lundeen, Novi, MI (US)

(73) Assignee: Ford Global Technologies, LLC, Dearborn, MI (US)

(21) Appl. No.: 17/804,481

(22) Filed: May 27, 2022

(51) Int. Cl. G05D 3/12; B60P 3/00; B60P 1/52

(52) U.S. Cl. CPC G05D 3/12; B60P 3/007; B60P 1/52

(57) ABSTRACT

Example embodiments described herein are directed to systems and methods related to moving a package in a delivery vehicle in a timely manner prior to the vehicle reaching a destination for the package. In an example embodiment, a computer identifies a target spot located ahead of the delivery destination. The computer then conveys an instruction to an automated package moving apparatus in the vehicle to initiate a movement of the package from a first location in a cargo area of the vehicle to a second location in the cargo area before or at a time of arrival of the vehicle at the target spot on the delivery route. The process of identifying the target spot on the delivery route can involve determining an amount of time to be allocated for the automated package moving apparatus to move the first package from the first location to the second location in the cargo area.

### BACKGROUND

Typically, a driver of a delivery vehicle places packages inside the delivery vehicle in an order that he/she personally prefers and then uses his/her memory to retrieve the right package at each delivery destination. Some of the more experienced drivers may become relatively efficient at carrying out deliveries in this manner. However, some less experienced drivers, as well as relatively disorganized drivers, may spend too much time in identifying, retrieving, and delivering the packages at the various destinations. It is desirable to address these and other shortcomings that exist in the use of delivery vehicles.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 shows a cut-away view of a delivery vehicle incorporating a first example embodiment of an automated package handling system in accordance with the disclosure.

FIG. 2 shows a first example bed of rollers that may be a part of a delivery vehicle in accordance with the disclosure.

FIG. 3 illustrates a first example package handling scenario in accordance with the disclosure.

FIG. 4 illustrates a second example package handling scenario in accordance with the disclosure.

FIG. 5 illustrates a third example package handling scenario in accordance with the disclosure.

FIG. 6 shows an example delivery route that includes several delivery stops for a delivery vehicle, in accordance with the disclosure.

FIG. 7 illustrates a first example graph depicting traffic speeds between two successive delivery stops of a delivery vehicle traveling in accordance with a scheduling procedure.

FIG. 8 illustrates a second example graph depicting traffic speeds between two successive delivery stops of a delivery vehicle traveling in accordance with a scheduling procedure.

FIG. 9 illustrates an example set of graphs depicting an optimal time to move packages between two successive delivery stops of a delivery vehicle traveling in accordance with a scheduling procedure.

FIG. 10 shows a flowchart of a procedure for moving a package transported in a delivery vehicle, in accordance with the disclosure.

FIG. 11 shows some example components that may be included in an automated package handling system in accordance with the disclosure.

### DETAILED DESCRIPTION

### Overview

In terms of a general overview, example embodiments described in this disclosure are directed to systems and methods related to moving a package in a delivery vehicle in a timely manner prior to the delivery vehicle reaching a destination for the package. As a result, when the driver arrives at the delivery destination, the package is already in the most convenient location for the driver to pick up from for final delivery, thereby minimizing the time spent at each destination. In one example embodiment, a computer identifies a target spot on a delivery route of a vehicle. The target spot is located ahead of a delivery destination for a package transported in the vehicle. The computer conveys an instruction to an automated package moving apparatus in the vehicle to initiate a movement of the package from a first location in a cargo area of the vehicle to a second location in the cargo area of the vehicle at a time of arrival of the vehicle at the target spot on the delivery route. The process of identifying the target spot on the delivery route can involve identifying the first location of the package in the cargo area of the vehicle, determining an amount of time to be allocated for the automated package moving apparatus to move the package from the first location to the second location in the cargo area of the vehicle, and identifying the target spot on the delivery route, based at least in part, on the amount of time allocated for the automated package moving apparatus to move the package from the first location to the second location in the cargo area of the vehicle.

### Illustrative Embodiments

The disclosure will be described more fully hereinafter with reference to the accompanying drawings, in which example embodiments of the disclosure are shown. This disclosure may, however, be embodied in many different forms and should not be construed as limited to the example embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described example embodiments but should be defined only in accordance with the following claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure. For example, any of the functionality described with respect to a particular device or component may be performed by another device or component. Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words, terms, and phrases are used herein solely for convenience and such words and terms should be interpreted as referring to various objects and actions that are generally understood in various forms and equivalencies by persons of ordinary skill in the art. For example, the word “vehicle” as used herein encompasses various types of automobiles such as vans and trucks that are driven by human operators and automobiles that are autonomously operated, and also encompasses other modes of transporting packages such as trailers that are detachably attached to vehicles. The phrase “autonomous vehicles” refers to automobiles that may be alternatively known by various other labels such as self-driving vehicles and robotic vehicles. The description below pertaining to a driver of a vehicle is equally applicable to a computer that controls operations of an autonomous vehicle. Thus, for example, an instruction provided by a computer to a driver of a driver-operated vehicle for performing an action upon the driver-operated vehicle should be considered as equally applicable to an instruction provided by the computer to a vehicle computer of an autonomous vehicle for performing a similar or identical action upon the autonomous vehicle. The word “item” and the word “package” may be used interchangeably in this disclosure. It must be understood that both words generally refer to various types of objects transported in a delivery vehicle, such as, for example, parcels, shipping boxes, consumable items (pizza, groceries, etc.), containers, unpackaged objects, and freight goods. The word “spot” and the word “location” may be used interchangeably in this disclosure. The word “example” as used herein is intended to be non-exclusionary and non-limiting in nature.

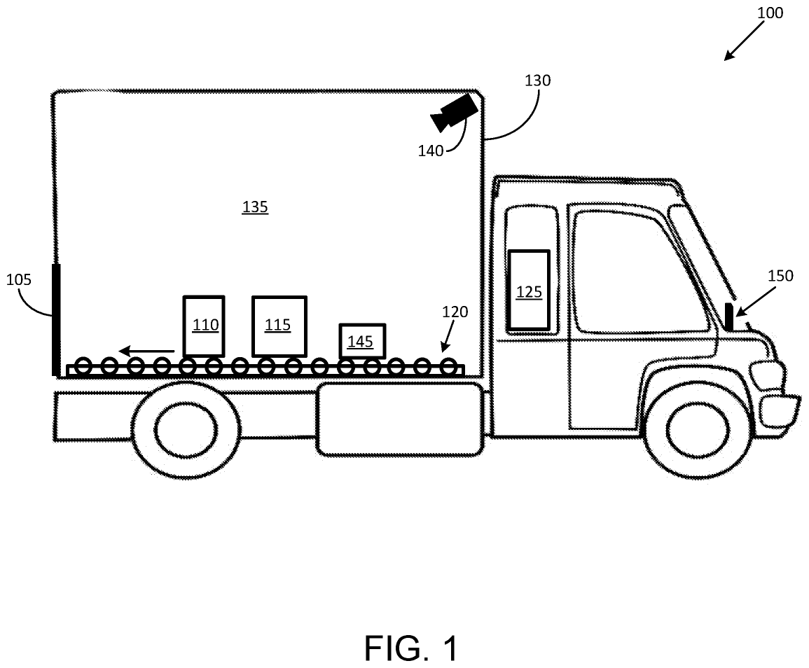

FIG. 1 shows a cut-away view of a delivery vehicle 130 incorporating an example embodiment of an automated package handling system 100 in accordance with the disclosure. The delivery vehicle 130 can be an autonomous vehicle in one example implementation and a driver-operated vehicle in another. The automated package handling system 100 includes an automated package moving apparatus located in a cargo area 135 of the delivery vehicle 130. The automated package moving apparatus may be implemented in various forms and can include elements such as, for example, a robotic platform, a robotic arm, a humanoid, a wheeled robot, a rail, a track, a conveyor belt, and/or a moving platform.

In the illustrated example embodiment, the automated package moving apparatus is implemented in the form of a bed of rollers 120 and a computer 125 that is configured to control the bed of rollers 120. Some, or all, of the rollers in the bed of rollers 120 may be coupled to servomotors (not shown) that can be activated via control signals from the computer 125 in order to rotate each roller in various directions.

In an example implementation, the computer 125 may provide a first type of control signal to a servomotor to make a roller rotate in a first direction and a second type of control signal to make the roller rotate in a second, or opposite direction. Providing the first type of control signal to the servomotor may involve applying a voltage of a first polarity to a terminal of the servomotor in order to make the roller rotate, for example, in a clockwise direction. Providing the second type of signal to the servomotor may involve applying a voltage of an opposite polarity to the terminal of the servomotor in order to make the roller rotate, for example, in a counter-clockwise direction.

In another example implementation, the computer 125 may provide a first type of control signal to move an axle of a roller in order to orient the roller in a first direction and a second type of control signal to orient the roller in a second direction. The second direction may be opposite to the first direction in one case and may be angular with respect to the first direction (45 degrees, for example) in another case.

In another example implementation, the computer 125 is configured to wirelessly communicate with another device such as, for example, a server computer (not shown) or a personal device (smartphone, tablet computer etc. that is not shown). The other device can be configured in accordance with the disclosure to perform various operations that supplement, complement, replicate, or replace operations performed by the computer 125. For example, a personal device may perform operations associated with identifying a target spot on a delivery route where it is desirable to start moving a package from one location to another location inside the cargo area of the delivery vehicle 130. Identifying the target spot is based on various factors that are described below and on ensuring that the package moving operation is completed prior to the delivery vehicle 130 reaching a delivery destination for the package. The personal device may communicate the information pertaining to the target spot to the computer 125, which uses the information to execute the action of moving the package inside the cargo area of the delivery vehicle 130. The moving operation is started when the delivery vehicle 130 reaches the target spot and is completed prior to the delivery vehicle 130 reaching the delivery destination.

The delivery vehicle 130 may include one or more exterior-facing doors at various locations such as, for example, an exterior-facing door 105 located in a rear portion of the delivery vehicle 130. Another exterior-facing door may be located, for example, on a side portion of the delivery vehicle 130 to allow an individual standing on a sidewalk to reach into the cargo area 135 of the delivery vehicle 130 for retrieving a package. In an example implementation, the delivery vehicle 130 may be a small vehicle and the layout of the cargo area 135 may preclude human presence. As such, an individual may be unable to climb into the cargo area 135 to retrieve a package.

In an example package delivery procedure in accordance with the disclosure, the computer 125 may cooperate with a global positioning system (GPS) device that can be a part of a navigation system 150 to determine a location of the vehicle, such as to determine that the delivery vehicle 130 has arrived at the target spot on the delivery route. The computer 125 may then identify a location of an item 110 upon the bed of rollers 120. In an example procedure to identify the location of the item 110, the computer 125 may evaluate images provided by a camera 140 located in the cargo area 135. The item 110 may be identified, for example, by reading a barcode label affixed to the item 110 and/or based on location coordinates of the item 110 placed upon the bed of rollers 120. In one case, the location coordinates may be determined by using a template of the bed of rollers 120 stored in a database of the computer 125.

After identifying the location of the item 110, the computer 125 provides control signals to a set of rollers in the bed of rollers 120 to move the item 110 from the location to a spot close to the exterior-facing door 105, for example. In this example implementation, the computer 125 may activate the set of rollers at a time of arrival of the delivery vehicle 130 at the target spot ahead of the delivery destination for the item 110. The computer 125 then ensures that the item 110 has been moved to the spot close to the exterior-facing door 105 before the delivery vehicle 130 reaches the delivery destination. The movement operation may be carried out either when the delivery vehicle 130 is in motion between the target spot and the delivery destination and/or when the delivery vehicle 130 is stopped at one or more intermediate spots between the target spot and the delivery destination. The intermediate spots can be, for example, traffic stops at traffic lights and vehicle stoppage due to traffic conditions.

Upon arriving at the delivery destination, the computer 125 may ensure that the delivery vehicle 130 is in a parked condition and then open the exterior-facing door 105 by transmitting a control signal to a servomotor that is coupled to the exterior-facing door 105. An individual, such as a customer or a driver of the delivery vehicle 130, for example, can then reach into the cargo area 135 through the exterior-facing door 105 to retrieve the item 110.

In some cases, particularly when the delivery vehicle 130 is an autonomous vehicle, additional structures such as, for example, movable and/or fixed panels, may be provided in the cargo area 135 of the delivery vehicle 130. The panels may be controlled by the computer 125 and configured to prevent the individual from having access to items not intended for the individual, such as, for example, a package 115 and a package 145 that are intended for delivery to other recipients.

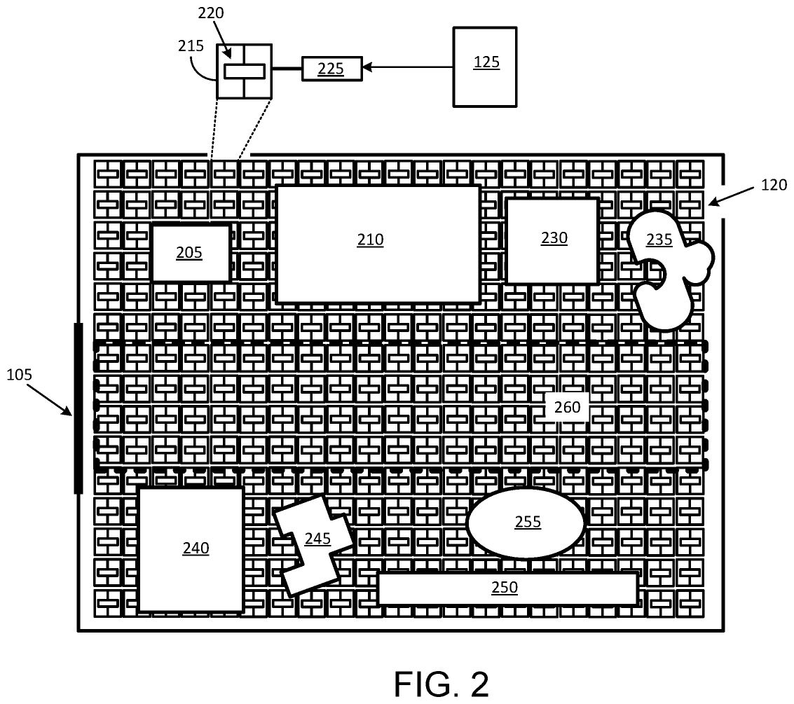

FIG. 2 shows the example bed of rollers 120 that can be a part of the delivery vehicle 130 in accordance with the disclosure. In this example embodiment, the bed of rollers 120 has a rectangular shape and the rollers are arranged in a matrix configuration. However, in other embodiments, the bed of rollers 120 can have other shapes and the rollers may be arranged in other configurations.

An expanded view of one of the rollers in the bed of rollers 120 includes a roller element 220 mounted on a base 215. The base 215 may be coupled to a servomotor 225 in an arrangement that allows the servomotor 225 to rotate the roller element 220. In a first example implementation, the roller element 220 may be a wheel mounted on an axial. The servomotor 225 can rotate the wheel in a clockwise direction when the computer 125 provides a first control signal to the servomotor 225. An item that is placed upon the bed of rollers 120 and in contact with at least the roller element 220 can be moved in a first direction when the roller element 220 rotates in the clockwise direction. The servomotor 225 can rotate the wheel in a counter-clockwise direction when the computer 125 provides a second control signal to the servomotor 225. The item that is placed upon the bed of rollers 120 and in contact with at least the roller element 220 can be moved in a second direction that is opposite to the first direction, when the roller element 220 rotates in the counter-clockwise direction. In a variation of this example implementation, the base 215 may include an axle that is pivotable such that the wheel can be aligned in various directions or the axle may be mounted in the base 215 with an angular orientation. This arrangement, which allows various items to be moved in various directions upon the bed of rollers 120, is described below with reference to another figure.

In a second example implementation, the roller element 220 may be a rollerball and the base 215 is a mounting fixture that allows the rollerball to rotate in various directions under control of the computer 125. An item that is placed upon the bed of rollers 120 and in contact with at least the roller element 220 can be moved in various directions so as to allow items to be moved in various directions upon the bed of rollers 120.

In an example scenario that is illustrated in FIG. 2, a package loading procedure may be used for placing various packages upon the bed of rollers 120. As a first step in an example package loading procedure, a movement area 260 may be defined for moving each package from the exterior-facing door 105 to a package storage space that includes various storage locations upon the bed of rollers 120. The movement area 260 may be defined on the basis of various criteria such as, for example, on the basis of the largest package that is to be loaded into the delivery vehicle 130 (in this example, a package 210), a shape of a package (for example, a shape of the package 235 or a package 245), and/or the storage location for the various packages. The shape of the movement area 260 in this example, is rectangular. However, the shape of the movement area 260 can be different in other scenarios. The movement area 260 may be also defined on the basis of a package placement configuration that precludes placement of any package on a set of rollers in the bed of rollers 120. The set of rollers are used for moving packages along a first movement path in the movement area 260 and it is desirable to prevent hindering a movement of a package on the first movement path from one location to another. Keeping the movement path clear is particularly beneficial when each package among a number of packages has to be moved from a respective storage location in the cargo area of the delivery vehicle 130 to the exterior-facing door 105 and/or when re-positioning a package from one storage location to another storage location when the delivery vehicle 130 is moving.

The storage location for each package upon the bed of rollers 120 may be determined next on the basis of various factors such as, for example, size, shape, weight, volume, delivery address, and delivery schedule. In a first example situation, larger packages may be placed farther from the exterior-facing door 105 than smaller packages. In a second example situation, heavier packages may be placed closer to the exterior-facing door 105 in comparison to lighter packages. In a third example situation, packages may be arranged in order of a delivery schedule. The delivery schedule may be based on various factors including, for example, delivery priorities (express delivery, regular delivery, overnight delivery, etc.). In the illustrated example, a package 205 is next in line for delivery, followed by a package 240, and these two packages are therefore placed close to the exterior-facing door 105.

In a fourth example situation, a weighting scheme may be applied to the packages. Accordingly, a higher weighting may be applied to an express delivery package in comparison to a regular delivery package. The weighting scheme, which may use a numerical format such as, for example, 8 out of 10 for a first package and 2 out of 10 for a second package, may be applied not only on the basis of delivery priorities but may be applied on the basis of any of various other factors as well, such as, for example, a heavier package may be assigned a higher weighting than a lighter package, a bulkier package may be assigned a higher weighting than a lighter package (or vice-versa), and an unboxed package may be assigned a higher weighting than a boxed package (or vice-versa).

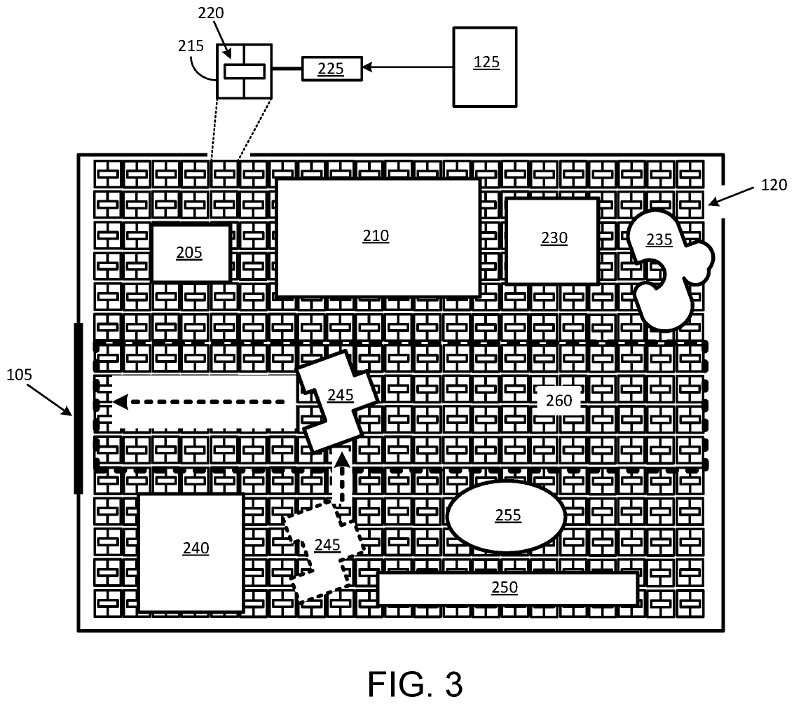

FIG. 3 illustrates a first example package handling scenario in accordance with the disclosure. The package handling scenario relates to a moving operation executed upon an example package 245 that is started when the delivery vehicle 130 reaches a target spot on a delivery route of the delivery vehicle 130 and is completed prior to the delivery vehicle 130 reaching a delivery destination for the package 245. In this example scenario, the computer 125 may cooperate with a GPS device in the delivery vehicle 130 to determine that the delivery vehicle 130 has arrived at the target spot.

The computer 125 then identifies a location of the package 245 upon the bed of rollers 120 by using the camera 140. After identifying the location of the package 245, the computer 125 provides control signals to a set of rollers in the bed of rollers 120 to move the package 245 to an unloading location adjacent to the exterior-facing door 105, via the movement area 260. The computer 125 ensures that the move is completed prior to the delivery vehicle 130 reaching the delivery destination for the package 245.

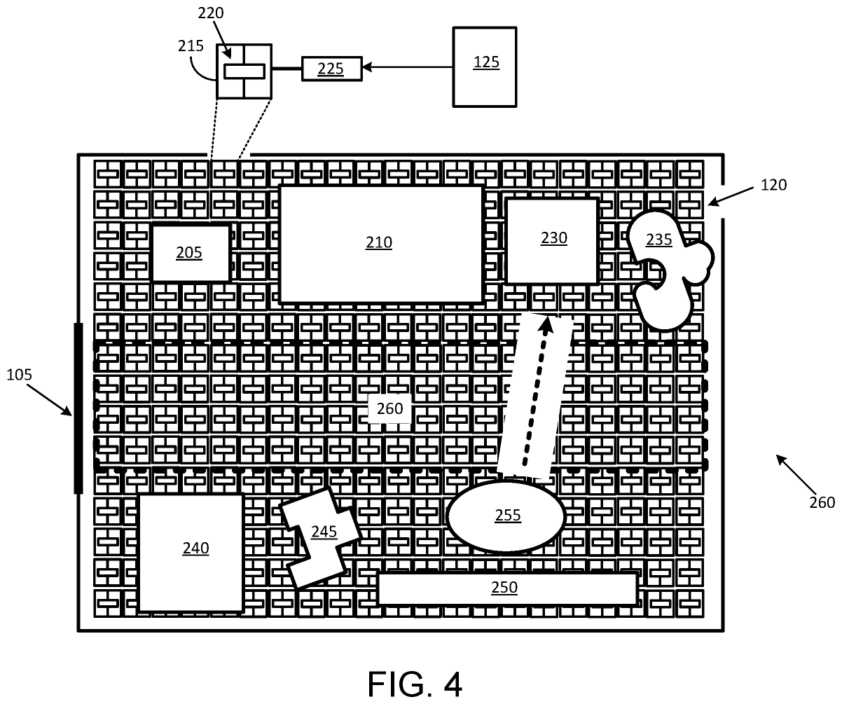

FIG. 4 illustrates a second example package handling scenario in accordance with the disclosure. The package handling scenario relates to moving an example package 250 to a spot close to the exterior-facing door 105. Movement of the package 250 into the movement area 260 is blocked by the package 255. It is therefore desirable to relocate the package 255 first before moving the package 250.

In this example scenario, the computer 125 identifies a location of the package 255 upon the bed of rollers 120 by using the camera 140. The computer 125 recognizes that moving of the package 250 to the spot close to the exterior-facing door 105 when the delivery vehicle 130 arrives at the target spot involves a first amount of time being spent to move the package 255 out of the way and a second amount of time to move the package 250 from its current storage location to the spot close to the exterior-facing door 105.

As a part of the moving process, the computer 125 determines and allocates a cumulative amount of time for moving the package 250 from its current storage location to the spot close to the exterior-facing door 105. The cumulative amount of time can be equal to a sum of the first amount of time and the second amount of time if the package 250 is moved immediately after the package 255 is moved (no delay in between). The cumulative amount of time can be greater than the sum of the first amount of time and the second amount of time if the package 250 is moved after a time delay following moving of the package 255.

Moving of the package 255 involves the computer 125 providing control signals to a set of rollers in the bed of rollers 120 to move the package 255 across the movement area 260 to a new storage location on the bed of rollers 120, thereby clearing the way for moving of the package 250 into the movement area 260 at the time when the delivery vehicle 130 reaches the target spot.

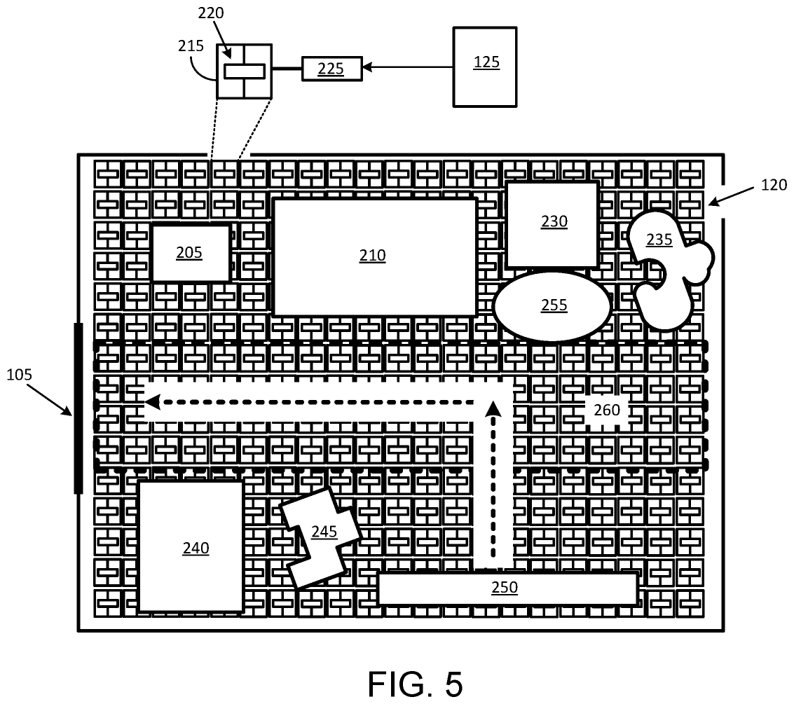

FIG. 5 illustrates a third example package handling scenario in accordance with the disclosure. The third package handling scenario may be carried out after execution of the second package handling scenario described above. In this example scenario, the computer 125 may cooperate with a GPS device in the delivery vehicle 130 to determine that the delivery vehicle 130 has arrived at the target spot. The computer 125 then provides control signals to a set of rollers in the bed of rollers 120 to move the package 250 into the movement area 260 and to a spot close to the exterior-facing door 105. The move is completed before the delivery vehicle 130 reaches the delivery destination for the package 250.

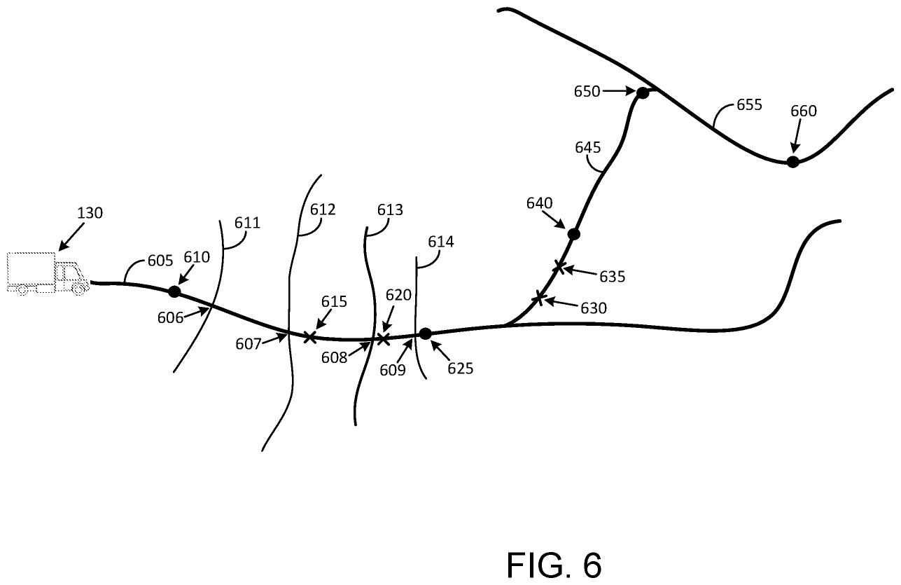

FIG. 6 shows an example delivery route that includes several delivery stops for the delivery vehicle 130, in accordance with the disclosure. The delivery route includes a first road 605, a second road 645, and a third road 655. The first road 605 includes a pickup spot 610 that may be a warehouse, for example, where packages are loaded into the delivery vehicle 130. The first road 605 further includes a first delivery stop 625, which is a delivery destination for dropping off a first package such as, for example, the package 245 or the package 250 described above. The delivery stop 640 can be a delivery destination for a second package. Other delivery destinations that are illustrated in FIG. 6 include a delivery stop 650 and a delivery stop 660.

In the illustrated example scenario, a first intersection 606 is present where a first road 611 intersects the road 605. A second intersection 607 is present where a second road 612 intersects the road 605. A third intersection 608 is present where a third road 613 intersects the road 605. A fourth intersection 609 is present where a fourth road 614 intersects the road 605. A nature of traffic movement between each pair of intersections can be different. For example, a level of traffic density on a road segment of the road 605 between the third intersection 608 and the fourth intersection 609 can be higher than a level of traffic density on a road segment of the road 605 between the first intersection 606 and the second intersection 607 because the road 613 may have more traffic than the first road 611.

Furthermore, an average speed of traffic on the various road segments can be different. For example, in spite of having a higher traffic density, the average speed of traffic on the road segment of the road 605 between the third intersection 608 and the fourth intersection 609 can be higher than the average speed of traffic on the road segment of the road 605 between the first intersection 606 and the second intersection 607 because the road segment of the road 605 between the third intersection 608 and the fourth intersection 609 is designed for fast moving traffic (an interstate highway, for example)

As indicated above, the delivery stop 625 is a delivery destination for a first package. The computer 125 in the delivery vehicle 130 (and/or a device that is wirelessly coupled to the computer 125 such as, for example, a personal device) is configured to execute certain operations in accordance with the disclosure for efficient delivery of the first package at the delivery stop 625. The efficient delivery includes moving the first package from a first location in the cargo area 135 of the delivery vehicle 130 to a second location in the cargo area 135 of the delivery vehicle 130 before the delivery vehicle 130 reaches the delivery stop 625.

The computer 125 can execute a scheduling procedure to identify, determine, and allocate an amount of time to the automated package moving apparatus for moving the first package from the first location to the second location in the cargo area 135. The second location can be located adjacent to the door 105 of the delivery vehicle 130. The scheduling procedure can include evaluating various factors such as, for example, a traffic density on the various road segments between the pickup spot 610 and the delivery stop 625, characteristics of the road segments (surface quality, gradient, curvature, etc.), characteristics of the delivery vehicle 130 (speed capability, terrain handling capacity, cargo area layout, etc.), and a current location of the first package in the cargo area 135 (for example, whether blocked by another package). These aspects are described below in further detail.

The scheduling procedure can further involve the computer 125 determining a target spot 615 on the road 605 that permits the automated package moving apparatus to use the allocated amount of time to move the first package from the first location to the second location inside the cargo area of the vehicle 130 before the vehicle 130 reaches a spot 620 that is located ahead of the delivery stop 625. More particularly, the automated package moving apparatus is configured to detect an arrival of the delivery vehicle 130 at the target spot 615 (for example, by using GPS signals) and to initiate a movement procedure for moving the first package at the time of arrival of the delivery vehicle 130 at the target spot 615.

After dropping off the first package at the first delivery stop 625, the computer 125 can repeat the scheduling procedure for configuring the automated package moving apparatus to use an allocated amount of time to move a second package inside the cargo area 135 of the delivery vehicle 130. In this scenario, the allocated amount of time can be different than the allocated amount of time described above with reference to the first package, based on, for example, various factors associated with movement of the delivery vehicle 130 on the road 645. More particularly, the automated package moving apparatus is configured to detect an arrival of the delivery vehicle 130 at a target spot 630 and to initiate a movement procedure upon the second package at the time of arrival of the delivery vehicle 130 at the target spot 630 and completing the move at, or prior to, a time of arrival of the delivery vehicle 130 at the spot 635.

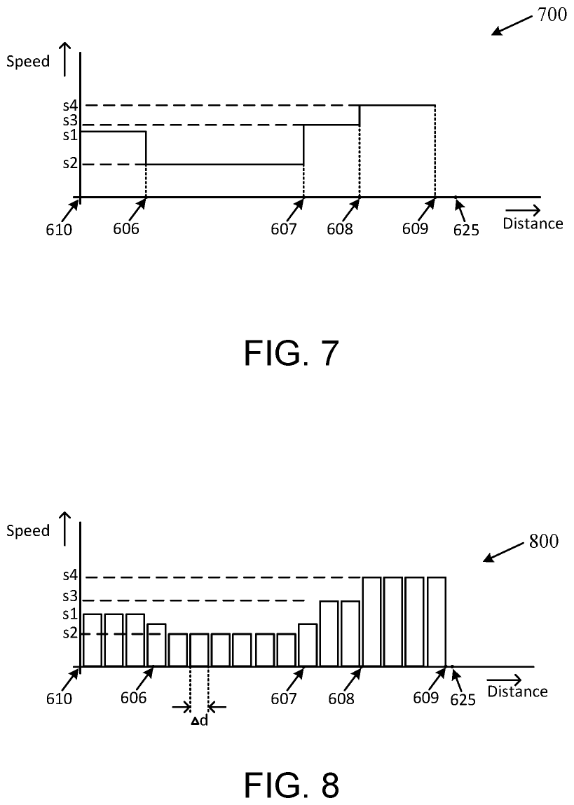

FIG. 7 illustrates a graph 700 associated with an example scheduling procedure to move a package transported in the delivery vehicle 130. The scheduling procedure can be executed by the computer 125 in the delivery vehicle 130 (and/or by a device that is wirelessly coupled to the computer 125 such as, for example, a personal device) at any suitable instant in time such as, for example, prior to the delivery vehicle 130 picking up packages at the warehouse at the pickup spot 610 or after the delivery vehicle 130 has picked up the packages at the warehouse and is moving towards the first delivery stop 625.

As described above, the scheduling procedure can include identifying, determining, and allocating an amount of time to the automated package moving apparatus for moving the first package from the first location to the second location in the cargo area 135. The scheduling procedure can further involve the computer 125 determining the target spot 615 (shown in FIG. 6) that permits the automated package moving apparatus to use the allocated amount of time to move the first package from the first location to the second location inside the cargo area of the vehicle 130 before the vehicle 130 reaches the spot 620 that is located ahead of the delivery stop 625.

The scheduling procedure can further include the computer 125 identifying the target spot 615 based on evaluating various factors such as, for example, a traffic density on the various road segments between the pickup spot 610 and the first delivery stop 625, characteristics of the road segments (surface quality, gradient, curvature, etc.), characteristics of the delivery vehicle 130 (speed capability, terrain handling capacity, cargo area layout, etc.), and a current location of the first package in the cargo area 135 (for example, whether blocked by another package).

Graph 700 may be used for evaluating factors related to traffic on the road 605. More particularly, the example graph 700 provides information pertaining to traffic speeds on each of four road segments of the road 605 between the pickup spot 610 and the delivery stop 625 estimated for the planned day and time of the delivery. A first road segment that extends from the pickup spot 610 to the first intersection 606 has a traffic speed indicated by “s1.” A second road segment that extends from the first intersection 606 to the second intersection 607 has a traffic speed indicated by “s2.” A third road segment that extends from the second intersection 607 to the third intersection 608 has a traffic speed indicated by “s3.” A fourth road segment that extends from the third intersection 608 to the fourth intersection 609 has a traffic speed indicated by “s4.”

Traffic speeds on the various segments may be determined on the basis of various factors such as, for example, a volume of traffic, a type of traffic, posted speed limit, condition of road, number of traffic lanes, traffic law enforcement, and time of day/week/year. Traffic speeds can also be derived directly either from history data or real-time traffic info widely available nowadays from navigation platforms, such as Google Maps™. In an example implementation, the traffic speeds indicated in the graph 700 may be specifically selected with reference to the delivery vehicle 130, which may vary based on various factors such as, for example, number of delivery stops on each segment, time allocated for each delivery, driver performance, and type of vehicle used.

FIG. 8 illustrates a graph 800 associated with an example scheduling procedure to move a package transported in the delivery vehicle 130. More particularly, the graph 800 is a finer and uniform discretized representation of the graph 700 described above. The discretized version provides speed values in discrete value form at a desired sampling rate and may be used by a computer such as, for example, the computer 125, for executing various operations in accordance with disclosure. Each sample may have a time period that corresponds to a fraction (Δd) of a distance between the pickup spot 610 and the first delivery stop 625.

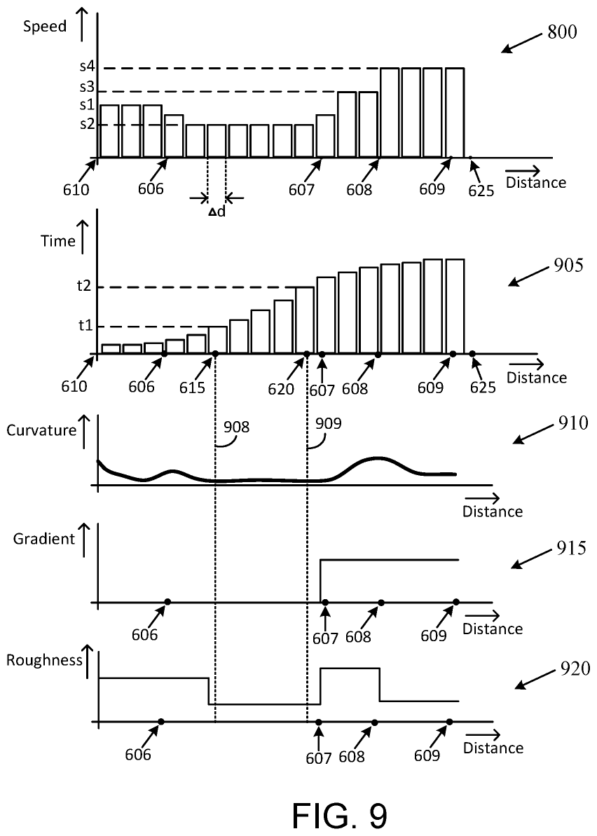

FIG. 9 illustrates an example set of graphs associated with an example scheduling procedure to move a package transported in the delivery vehicle 130. As described above, the scheduling procedure can include identifying, determining, and allocating an amount of time to the automated package moving apparatus for moving the first package from the first location to the second location in the cargo area 135. More particularly, the example graph 905 provides information pertaining to an amount of time that may be expended by the delivery vehicle 130 to traverse each of four road segments of the road 605 between the pickup spot 610 and the first delivery stop 625. This graph can be obtained by performing a numeric integration of the time needed to travel a unit distance Δd in the example graph 800 over the distance from 610 to 625. Further, time needed to travel the unit distance Δd can be calculated by dividing Δd by the corresponding speed found in graph 800.

In an example implementation, the number of discrete intervals that may be used for executing a numerical integration procedure to compute a time of travel between the pickup spot 610 and the first delivery stop 625 can be determined based on the following equation:

jₘₐₓ=INT((D₆₂₅−D₆₁₀)/Δd)

where D₆₂₅ represent the driving distance from stop 625 from the start of the delivery trip and D₆₁₀ from stop 610 from the start. jₘₐₓ is the number of uniform discrete intervals in driving distance from stop 610 to 625.

The time needed to traverse “j” number of intervals can be determined based on use of the following equation to determine an amplitude of each time sample of graph 905:

Tj=Σₗ₌₁^{j}Δd/sl for j=1,jₘₐₓ

An example time interval extending between t₁ and t₂ represents an estimated amount of time needed to complete a movement of a package from a first position to a second position in the cargo area 135 of the vehicle 130 while the vehicle 130 travels on the delivery route. The example time interval extending between t₁ and t₂ can correspond to a separation distance between the target spot 615 and the spot 620 on the graph 905 (target spot 615 and spot 620 are also shown in FIG. 6). The separation distance is represented by a pair of lines (line 908 and line 909) that can be used as a sliding window, which can be moved anywhere along the x-axis of the graph 905. The sliding window can be positioned anywhere between the pickup spot 610 and the first delivery stop 625 along the x-axis of the graph 905.

Typically, the time interval from t₁ to t₂ is shorter than time needed to travel from stop 610 to 625. In case it is longer, it should be obvious to those skilled in the art that disclosed method can be executed in part when the vehicle is driving and in part after the vehicle arrives at the stop 625.

The sliding window may also be moved in correspondence to the graph 910, the graph 915, and the graph 920. Graph 905 pertains to road curvature, graph 915 pertains to road gradient, and graph 920 pertains to road surface roughness. The road curvature, road gradient, and/or road roughness can have an effect upon an amount of time that is needed for moving the package from a first position to a second position in the cargo area 135 of the vehicle 130 while the vehicle 130 travels on the delivery route.

More particularly, the road curvature, road gradient, and/or road roughness can affect an orientation of a chassis of the vehicle 130, which in turn can affect an orientation of the bed of rollers 120 on which the package is moved in the cargo area 135. The orientation of the bed of rollers 120 can include a tilt in one or more of three directions that may be defined by an x-y-z axes. For example, a road gradient can cause one end of the bed of rollers 120 to be located higher than the other end of the bed of rollers 120, a road curvature can cause the package to move in a lateral direction and/or skew on the bed of rollers 120, and road roughness can cause the package to bounce up and down on the bed of rollers 120. Such situations can lead to adverse movement conditions that may require addressing such as, for example, a need to apply more pressure upon a package to move the package, correcting a direction of movement of a package, and/or pausing a movement of a package. Such actions can adversely affect an amount of time needed to move the package in the cargo area 135.

Consequently, as a part of an example scheduling procedure, an optimal movement period (difference between line 908 and line 909) and/or an optimal time period (difference between t1 and t2) can be determined by moving the sliding window (indicated by the pair of lines) in either direction along the x-axis of the graph 905 and with reference to the graph 910, the graph 915, and/or the graph 920. The illustrated example position of the pair of lines corresponds to a relatively low road curvature (graph 910), zero gradient (graph 915), and low road roughness (graph 920).

The movement characteristics of the delivery vehicle 130 can also affect the time needed for moving the package in the cargo area 135. For example, a change in speed of the vehicle (for example, due to acceleration or braking) can cause the package to shift in a direction that is aligned to a longitudinal axis of the delivery vehicle 130. A turning operation can cause the package to shift in a lateral direction that is aligned to a traverse axis of the delivery vehicle 130 or to be skewed. Consequently, the movement characteristics of the delivery vehicle 130 may also be taken into consideration when determining a time of movement of a package inside the cargo area 135 of the vehicle 130.

The example scheduling procedure described above with respect to a part of the delivery route extending from the pickup spot 610 to the first delivery stop 625 can be replicated for other road sections such as for example, from the first delivery stop 625 to the second delivery stop 640 (for determining the target spot 630 and the spot 635 shown in FIG. 6).

The information derived from the scheduling procedure can be executed in real time by the computer 125 at a suitable instant in time such as, for example, after the delivery vehicle 130 has picked up the packages at the warehouse and is moving towards the first delivery stop 625. In an exemplary implementation, the execution can include determining a condition score Q that is a weighted average of various factors. The condition score Q can be defined by the following equation:

Q=w₁*aₓ+w₂*a_{y}+w₃*a_{z}

where aₓ, a_{y}, and a_{z} are factors associated with acceleration characteristics of the delivery vehicle 130 in longitudinal, lateral, and vertical directions respectively, and w₁, w₂, and w₃ are chosen weights. The factors aₓ, a_{y}, and a_{z} can be obtained, for example, from an inertial measurement unit (IMU) installed in the delivery vehicle 130. The larger the value of Q, the less favorable the condition under which a package can be moved. The condition score Q can be determined at various times such as, for example, at regular intervals (@ 1 Hz, for example). A moving average of the condition score can be determined over a period of time such as, for example, over a minute, and used by the computer 125 to identify the parameters described above with reference to FIG. 8 and FIG. 9.

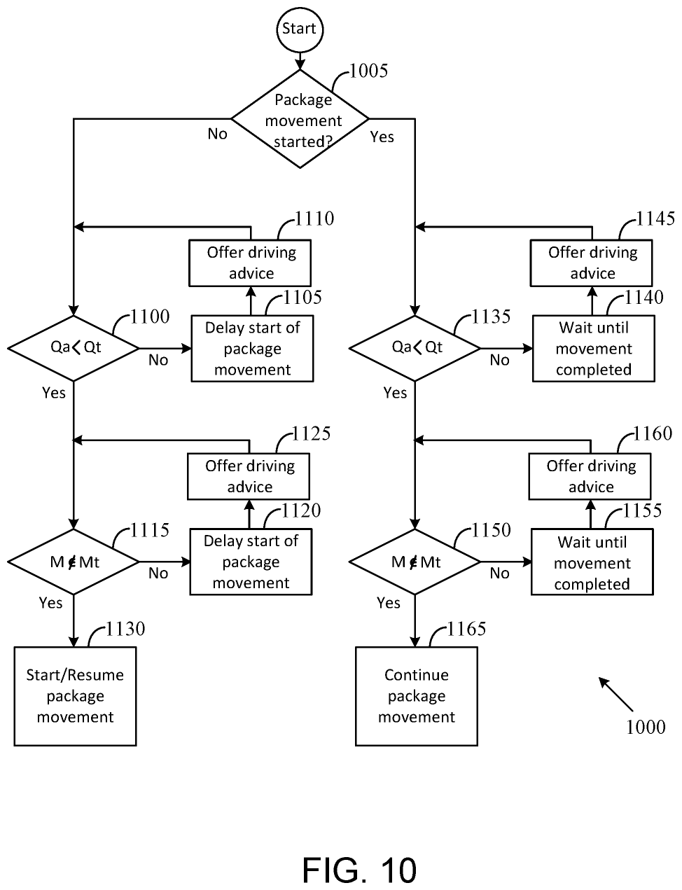

FIG. 10 shows a flowchart 1000 of a procedure to timely move a package transported in a delivery vehicle, in accordance with the disclosure. The actions indicated in the various blocks of the flowchart 1000 can be executed by the computer 125 provided in the delivery vehicle 130. At block 1005, a determination is made whether a movement of a package has been started in the cargo area 135 of the vehicle 130. If the movement has not yet been started, at block 1100, a determination is made whether Qₐ<Qₜ where Qₐ is an averaged condition score and Qₜ is a threshold value that may be used to determine whether the conditions are safe to move the package from the first position to the second position in the cargo area 135 of the vehicle 130.

If the condition Qₐ<Qₜ that is indicated in at block 1105 is not satisfied (i.e., Qₐ>Qₜ, for example) movement of the package is delayed. The delay period can vary based on various factors such as, for example, a delivery schedule and/or road conditions. At block 1110, the computer 125 may provide driving advice to a driver of the delivery vehicle 130 (or to a vehicle computer of an autonomous vehicle). The driving advice can include, for example, a recommendation to slow down the delivery vehicle 130. The action indicated in block 1100 is then executed once again. Block 1100, block 1105, and block 1110 can be execute reiteratively until conditions improve and Qₐ<Qₜ.

When conditions improve and Qₐ<Qₜ, a determination is made in block 1115 whether MεMₛ (where M is a driving mode and Mₛ is a set of unfavorable driving modes for driving in poor conditions such as, for example, in snow, sand, mud, or gravel. If MεMₛ, at block 1120 movement of the package is delayed. At block 1125, the computer 125 may provide driving advice to a driver of the delivery vehicle 130 (or to a vehicle computer of an autonomous vehicle). The driving advice can include, for example, a recommendation to slow down the delivery vehicle 130. The action indicated in block 1115 is then executed once again.

Block 1115, block 1120, and block 1125 can be execute reiteratively until conditions improve and MεMₛ. If MεMₛ, at block 1130, movement of the package in the cargo area 135 is started.

If at block 1005, movement of the package has been started, at block 1135, a determination is made whether Qₐ<Qₜ where Qₐ is an averaged condition score and Qₜ is a threshold value that may be used to determine whether the conditions are safe to move the package from the first position to the second position in the cargo area 135 of the vehicle 130.

If the condition Qₐ<Qₜ that is indicated in block 1140 is not satisfied (i.e., Qₐ>Qₜ, for example) movement of the package is delayed. The delay period can vary based on various factors such as, for example, a delivery schedule and/or road conditions. At block 1145, the computer 125 may provide driving advice to a driver of the delivery vehicle 130 (or to a vehicle computer of an autonomous vehicle). The driving advice can include, for example, a recommendation to slow down the delivery vehicle 130. The action indicated in block 1135 is then executed once again. Block 1135, block 1140, and block 1145 can be execute reiteratively until conditions improve and Qₐ<Qₜ.

When conditions improve and Qₐ<Qₜ, a determination is made in block 1150 whether MεMₛ (where M is a driving mode and Mₛ is a set of unfavorable driving modes for driving in poor conditions such as, for example, in snow, sand, mud, or gravel. If MεMₛ, at block 1155 movement of the package is delayed. At block 1160, the computer 125 may provide driving advice to a driver of the delivery vehicle 130 (or to a vehicle computer of an autonomous vehicle). The driving advice can include, for example, a recommendation to slow down the delivery vehicle 130. The action indicated in block 1150 is then executed once again.

Block 1150, block 1155, and block 1160 can be execute reiteratively until conditions improve and MεMₛ. If MεMₛ, at block 1165, movement of the package in the cargo area 135 is continued.

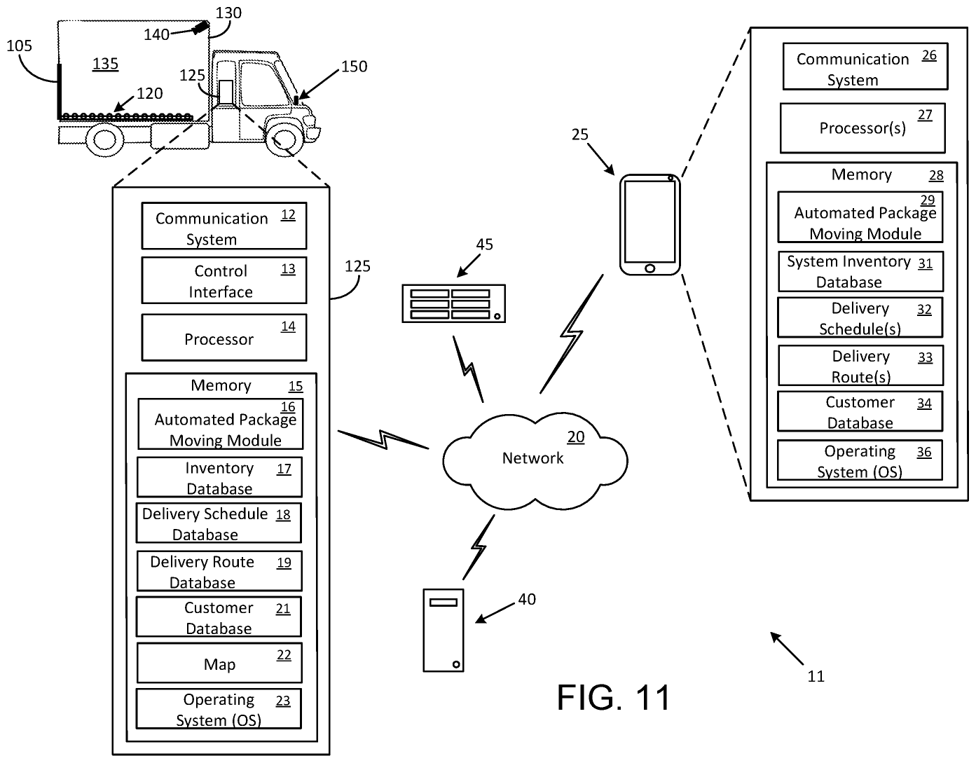

FIG. 11 shows an example network-based implementation of an automated package handling system 11 in accordance with the disclosure. The automated package handling system 11 may include a network 20 that provides communicative coupling between the computer 125, a personal device 25, a server computer 40, and a cloud storage element 45. The personal device 25, which can be any of various devices such as, for example, a smartphone, a package scanner, a laptop computer, or a tablet computer, may be carried by an individual such as, for example, a driver of the delivery vehicle 130, a person loading packages into the delivery vehicle 130, a person unloading packages from the delivery vehicle 130, or an operations manager located at any of various locations.

The network 20 can include any one or a combination of a local area network (LAN), a telephone network, a cellular network, a cable network, a wireless network, and/or private/public networks such as the Internet. In some instances, the network 20 may support various wired, wireless, and optical technologies, including Bluetooth, cellular, near-field communication (NFC), Wi-Fi, and/or Wi-Fi direct.

The computer 125 that is provided in the delivery vehicle 130 may include several components such as, for example, a communication system 12, a control interface 13, a processor 14, and a memory 15. The communication system 12 may be configured to allow communications between the computer 125, the server computer 40, the personal device 25, and the cloud storage element 45 via the network 20. The control interface 13 may be configured to transmit control signals to servomotors coupled to various rollers in the bed of rollers 120.

The memory 15, which is one example of a non-transitory computer-readable medium, may be used to store various code modules and various types of data. For example, the memory 15 may be configured to store an automated package handling module 16, an inventory database 17, a delivery schedule database 18, a delivery route database 19, a customer database 21, a map 22 of the cargo area of the delivery vehicle 130, and an operating system (OS) 23.

The automated package handling module 16 may include computer-executable instructions for executing various automated package handling procedures in accordance with the disclosure. More particularly, the automated package handling module 16 can include software for performing operations associated with an aggregator, a scheduler, an assessor, and a director in accordance with the disclosure. The aggregator can be executed by the processor 14 for aggregating various types of data obtained from various sources such as, for example, from the server computer 40 and/or the cloud storage element 45. The data can provide information such as, for example, road network information, road grade information, and real time traffic information. The scheduler can be executed by the processor 14 for performing scheduling procedures such as the example procedures described above. The assessor can be executed by the processor 14 for evaluating conditions such as, for example, a travel time, a travel environment, and a travel factor, before and/or during moving of a package from one location to another in the cargo area 135 of the vehicle 130. The operating conditions can include for example, road conditions (curvature, grade, roughness, etc.) and vehicle conditions (speed, vibration, inclination, etc.). The director can be executed by the processor 14 for executing the moving operation of the package from one location to another in the cargo area 135 of the vehicle 130. The moving operation can be based on information provided by the scheduler. In an example implementation, the director is based on the flowchart illustrated in FIG. 10.

In an example moving operation, the processor 14 executes the computer-executable instructions stored in the memory 15 to perform operations that include, for example, identifying a location of an item placed upon the bed of rollers 120, activating at least some rollers in the bed of rollers 120 to move the item from a first storage location on the bed of rollers 120 to a spot close to the exterior-facing door 105, or to move the item from a first storage location on the bed of rollers 120 to a second storage location on the bed of rollers 120 while the delivery vehicle 130 is in transit.

The processor 14 may also communicate with a GPS device that can be a part of the navigation system 150 in order to determine a current location of the delivery vehicle 130 along a delivery route that may be identified by using information stored in the delivery route database 19. The processor 14 may then access the delivery schedule database 18 and the customer database 21 to determine, for example, an identity of the package 245 (shown in FIG. 2), followed by accessing the map 22 of the cargo area of the delivery vehicle 130 to identify the location of the package 245 on the bed of rollers 120. The map 22 may be dynamically updated each time one or more items are moved upon the bed of rollers 120 so as to provide accurate and up-to-date location information of the various items placed upon the bed of rollers 120.

After identifying the location of the package 245 on the bed of rollers 120, the processor 14 may use the control interface 13 to transmit control signals to a set of rollers upon which the package 245 is placed so as to move the package 245 close to the exterior-facing door 105. The processor 14 may operate the exterior-facing door 105 after detecting stoppage of the delivery vehicle 130 at the delivery location so as to allow a customer to retrieve the package 245 through the exterior-facing door 105.

In one example implementation, the personal device 25 can include various components such as, for example, a communication system 26, a processor 27, and a memory 28. The communication system 26 may be configured to communicate with the computer 125 and/or the server computer 40, and/or the cloud storage element 45 through the network 20. The memory 28, which is one more example of a non-transitory computer-readable medium, may be used to store various code modules and various types of data. For example, the memory 28 may be configured to store an automated package handling module 29, a system inventory database 31, one or more delivery schedules 32, one or more delivery routes 33, a customer database 34, and an operating system (OS) 36. In an example implementation, the automated package handling module 29 may be downloaded into the personal device 25 in the form of a software application that may be stored in the server computer 40 and/or in the cloud storage element 45.

In an example mode of operation, the processor 27 executes the computer-executable instructions stored in the memory 28 to perform some operations in cooperation with the computer 125 provided in the delivery vehicle 130. For example, the processor 27 may use data stored in the memory 28 (such as the system inventory database 31, the delivery schedules 32, the delivery routes 33, and the customer database 34) to execute a scheduling procedure and may convey information derived from executing the scheduling procedure to the computer 125 in the vehicle 130 in accordance with the disclosure.

A memory device such as the memory 15 and the memory 28 described above can include any one memory element or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory device may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The server computer 40 can contain some of the components provided in the computer 125 and/or the personal device 25. The server computer 40 may be implemented in the form of a single computer or a networked set of computers that can communicate with the computer 125 in the delivery vehicle 130, and the personal device 25.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” “an example implementation” etc., indicate that the embodiment or implementation described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize one or more devices that include hardware, such as, for example, one or more processors and system memory, as discussed herein.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, cause the processor to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the present disclosure may be practiced in network computing environments with many types of computer system configurations, including in-dash vehicle computers, personal computers, desktop computers, laptop computers, message processors, mobile devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
determining, by a computer, a target spot on a delivery route of a vehicle, the target spot located ahead of a delivery destination for a first package transported in the vehicle; and
determining, by the computer, a first instruction to an automated package moving apparatus in the vehicle to initiate a movement of the first package from a first location in a cargo area of the vehicle to a second location in the cargo area of the vehicle one of before or at a time of arrival of the vehicle at the target spot on the delivery route.

2. The method of claim 1, wherein the second location in the cargo area of the vehicle is adjacent to a door in the cargo area of the vehicle.

3. The method of claim 1, wherein determining the target spot on the delivery route comprises:
identifying, by the computer, the first location of the first package in the cargo area of the vehicle;
determining, by the computer, a first amount of time to be allocated for the automated package moving apparatus to move the first package from the first location to the second location in the cargo area of the vehicle; and
identifying, by the computer, the target spot on the delivery route, based at least in part, on the first amount of time allocated for the automated package moving apparatus to move the first package from the first location to the second location in the cargo area of the vehicle.

4. The method of claim 3, wherein determining the target spot on the delivery route further comprises:
determining, by the computer, a first travel time for the vehicle from the target spot to the delivery destination for the first package; and
identifying the target spot on the delivery route subject to the first amount of time being less than the first travel time.

5. The method of claim 4, wherein determining the target spot on the delivery route further comprises:
determining, by the computer, a second travel time for the vehicle from a reference spot that is ahead of the target spot on the delivery route; and
identifying the target spot on the delivery route based on the first travel time and the second travel time.

6. The method of claim 5, wherein determining the second travel time comprises:
evaluating, by the computer, at least one travel factor that is applicable between at least the reference spot and the target spot.

7. The method of claim 6, wherein the at least one travel factor comprises a first factor associated with a characteristic of a road that is a part of the delivery route, a second factor associated with a travel environment for the vehicle on the road, and/or a third factor associated with a performance of the vehicle on the road.

8. A method comprising:
determining, by a computer, based on evaluating a delivery route, an operating schedule for an automated package moving apparatus in a vehicle; and
providing, by the computer, to the automated package moving apparatus, based on the operating schedule, a first instruction to initiate a movement of a first package from a first location in a cargo area of the vehicle to a second location in the cargo area of the vehicle at a time of arrival of the vehicle at a target spot on the delivery route, the target spot located ahead of a delivery destination for the first package.

9. The method of claim 8, further comprising:
identifying, by the computer, the first location of the first package in the cargo area of the vehicle;
determining, by the computer, a first amount of time to be allocated for the automated package moving apparatus to move the first package from the first location to the second location in the cargo area of the vehicle; and
identifying, by the computer, the target spot on the delivery route, based at least in part, on the first amount of time allocated for the automated package moving apparatus to move the first package from the first location to the second location in the cargo area of the vehicle.

10. The method of claim 9, wherein identifying the target spot on the delivery route further comprises:
determining, by the computer, a first travel time for the vehicle from the target spot to the delivery destination for the first package; and
identifying the target spot on the delivery route subject to the first amount of time being less than the first travel time.

11. The method of claim 8, wherein evaluating the delivery route comprises:
evaluating a first factor associated with a characteristic of a road that is a part of the delivery route and/or a second factor associated with a travel environment for the vehicle on the road.

12. The method of claim 11, wherein the characteristic of the road comprises a surface quality, a gradient, and/or a curvature.

13. The method of claim 8, further comprising:
evaluating an orientation of a chassis of the vehicle;
determining, based on the orientation of the chassis, a first amount of force to be applied for moving the first package; and
moving the first package from the first location to the second location in the cargo area by applying the first amount of force.

14. The method of claim 13, wherein the orientation of the chassis of the vehicle is defined by a surface quality, a gradient, and/or a curvature of a road that is a part of the delivery route.

15. A system comprising:
a vehicle that includes an automated package moving apparatus; and
a computer comprising:
a memory that stores computer-executable instructions; and
a processor configured to access the memory and execute the computer-executable instructions to perform operations comprising:
identifying a target spot on a delivery route of the vehicle, the target spot located ahead of a delivery destination for a first package transported in the vehicle; and
conveying to the automated package moving apparatus, a first instruction to initiate a movement of the first package from a first location in a cargo area of the vehicle to a second location in the cargo area of the vehicle at a time of arrival of the vehicle at the target spot on the delivery route.

16. The system of claim 15, wherein the processor is further configured to access the memory and execute additional computer-executable instructions to perform operations comprising:
evaluating an orientation of a chassis of the vehicle;
determining, based on the orientation of the chassis, a first amount of force to be applied for moving the first package; and
moving the first package from the first location to the second location in the cargo area by applying the first amount of force.

17. The system of claim 16, wherein the orientation of the chassis of the vehicle is defined by a surface quality, a gradient, and/or a curvature of a road that is a part of the delivery route.

18. The system of claim 15, wherein the automated package moving apparatus comprises a bed of rollers provided in the cargo area of the vehicle, the bed of rollers operated by servomotors under control of the processor.

19. The system of claim 18, wherein the second location is an unloading location adjacent to a door of the vehicle and wherein the processor is further configured to access the memory and execute additional computer-executable instructions to perform operations comprising:
identifying the first location in the cargo area of the vehicle;
determining a first movement path for the first package upon the bed of rollers, the first movement path extending between the first location and the unloading location adjacent to the door of the vehicle; and
activating a first set of rollers in the bed of rollers, to automatically move the first package along the first movement path from the first location to the one of the second location in the cargo area of the vehicle or the unloading location adjacent to the door of the vehicle.

20. The system of claim 18, wherein the second location is an unloading location adjacent to a door of the vehicle and wherein the processor is further configured to access the memory and execute additional computer-executable instructions to perform operations comprising:
identifying an arrival of the vehicle at the first location; and
activating, based on the arrival of the vehicle at the first location, a first set of rollers in the bed of rollers to automatically move the first package from the first location to the unloading location adjacent to the door of the vehicle.
